(19) United States
(12) Patent Application Publication
(10) Pub. No.: US 2017/0201741 A1
(43) Pub. Date: Jul. 13, 2017

(54) ADD-ON AUXILIARY DEVICE FOR ASSISTING IN GENERATING THREE-DIMENSIONAL INFORMATION

(71) Applicant: Jia-Lung Wang, Zhubei City (TW)

(72) Inventor: Jia-Lung Wang, Zhubei City (TW)

(73) Assignee: EOSMEM Corporation, Zhubei City (TW)

(21) Appl. No.: 15/066,014

(22) Filed: Mar. 10, 2016

(30) Foreign Application Priority Data
Jan. 11, 2016 (TW) 105200315

(51) Int. Cl. H04N 13/02; H04N 5/232

(52) U.S. Cl. CPC H04N 13/0282; H04N 13/0296; H04N 5/23209

(57) ABSTRACT

The present invention provides an add-on auxiliary device for assisting in generating three-dimensional information. The portable electronic device includes a first image sensor and a processing circuit. The first image sensor captures first two-dimensional information of an object. The processing circuit is coupled to the first image sensor, for processing the first two-dimensional information. The add-on auxiliary device includes at least one second image sensor and a transmission line. The second image sensor captures second two-dimensional information of the object. The second two-dimensional information is transmitted to the processing circuit via the transmission line, whereby the processing circuit generates three-dimensional information of the object according to the first two-dimensional information and the second two-dimensional information. Or, the processing circuit generates three-dimensional information of the object according to plural second two-dimensional information.

### CROSS REFERENCE

The present invention claims priority to TW 105200315, filed on Jan. 11, 2016.

### BACKGROUND OF THE INVENTION

Field of Invention

The present invention relates to an add-on auxiliary device for assisting in generating three-dimensional information; particularly, it relates to such add-on auxiliary device, which is an external device that can be attached or linked to a portable electronic device having a camera function, for assisting in generating three-dimensional information.

Description of Related Art

Please refer to FIG. 1, which shows a block diagram of a conventional portable electronic device having a camera function. The conventional portable electronic device 100 includes one single image senor 13 (for convenience in comparison with the present invention, the image senor 13 of the prior art is hereinafter described as “first image senor 13”) and a processing circuit 14. The first image senor 13 is coupled to the processing circuit 14. The first image senor captures an image of an object P and generates two-dimensional information SD corresponding to the object P, and such two-dimensional information SD is transmitted to the processing circuit 14. The processing circuit 14 then generates two-dimensional image file SF of the object P, which can be displayed, for example, on a screen of the conventional portable electronic device 100. The two-dimensional image file SF may include information of several millions to several hundred millions of pixels. For simplicity, the two-dimensional image file SF of the object P is represented as P (X, Y), wherein X denotes the X coordinates of the object P and Y denotes the Y coordinates of the object P.

The conventional portable electronic device 100 includes only one single first image senor 13. It is unable to generate three-dimensional information of the object P through one single first image senor 13, so the conventional portable electronic device 100 cannot take three-dimensional photos. If a user intends to take three-dimensional photos, he has to purchase a whole new portable electronic device having a three-dimensional photo taking function, which is certainly costly.

In view of the above, the present invention proposes an add-on auxiliary device for assisting in generating three-dimensional information. The add-on auxiliary device is an external device that can be attached or linked to a portable electronic device having only a two-dimensional camera function, to generate three-dimensional information.

### SUMMARY OF THE INVENTION

In one perspective, the present invention provides an add-on auxiliary device for assisting in generating three-dimensional information, wherein the add-on auxiliary device is an external device configured to be attached or linked to a portable electronic device having a camera function, the portable electronic device including a first image sensor configured to operably capture first two-dimensional information of an object and a processing circuit coupled to the first image sensor, wherein the processing circuit is configured to operably process the first two-dimensional information, the add-on auxiliary device comprising: at least one second image sensor configured to operably capture second two-dimensional information of the object; and a transmission line configured to operably transmit the second two-dimensional information to the processing circuit; whereby, the processing circuit generates three-dimensional information of the object according to the first two-dimensional information and the second two-dimensional information.

In one embodiment, after a fixed delay time which is computed according to an occurrence of a specific event, the second image sensor captures the second two-dimensional information of the object, so that an image capturing time of the second two-dimensional information is synchronous with an image capturing time of the first two-dimensional information captured by the first image sensor.

In one embodiment, the portable electronic device has a built-in flash module, and as the add-on auxiliary device senses a flash timing of the built-in flash module, the second image sensor captures the second two-dimensional information of the object, so that an image capturing time of the second two-dimensional information is synchronous with an image capturing time of the first two-dimensional information captured by the first image sensor.

From another perspective, the present invention provides an add-on auxiliary device for assisting in generating three-dimensional information, wherein the add-on auxiliary device is an external device configured to be attached or linked to a portable electronic device having a camera function, the portable electronic device including a first image sensor configured to operably capture first two-dimensional information of an object and a processing circuit coupled to the first image sensor, wherein the processing circuit is configured to operably process the first two-dimensional information, the add-on auxiliary device comprising: a plurality of second image sensors configured to operably capture a plurality of second two-dimensional information of the object; and a transmission line configured to operably transmit the plurality of second two-dimensional information to the processing circuit; whereby, the processing circuit generates the three-dimensional information of the object according to the plurality of second two-dimensional information.

From yet another perspective, the present invention provides an add-on auxiliary device for assisting in generating three-dimensional information, wherein the add-on auxiliary device is an external device configured to be attached or linked to a portable electronic device having a camera function, the portable electronic device including a first image sensor configured to operably capture first two-dimensional information of an object and a processing circuit coupled to the first image sensor, wherein the processing circuit is configured to operably process the first two-dimensional information, the add-on auxiliary device comprising: a plurality of second image sensors configured to operably capture a plurality of second two-dimensional information of the object; a three-dimensional image processing circuit configured to operably generate the three-dimensional information of the object according to the plurality of second two-dimensional information; and a transmission line configured to operably transmit the three-dimensional information to the processing circuit.

In one embodiment, the add-on auxiliary device further comprises: an extension flash module configured to operably provide supplemental light while the second image sensor is capturing the second two-dimensional information of the object.

In one embodiment, the extension flash module is configured to trigger a flash after a fixed delay time from an occurrence of a specific event, wherein the specific event is a timing at which a photo sensor row of the first or the second image sensor begins exposure or ends exposure.

In one embodiment, the portable electronic device has a built-in flash module, and the add-on auxiliary device further comprises: a photo sensing circuit configured to operably sense a flash timing of the built-in flash module, wherein the add-on auxiliary device is controlled by the photo sensing circuit to flash according to the flash timing of the built-in flash module.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a block diagram of a conventional portable electronic device having a camera function.

FIG. 2 shows a block diagram of an add-on auxiliary device for assisting in generating three-dimensional information according to a first embodiment of the present invention.

FIG. 3 shows a block diagram of an add-on auxiliary device for assisting in generating three-dimensional information according to a second embodiment of the present invention.

FIG. 4 shows a block diagram of an add-on auxiliary device for assisting in generating three-dimensional information according to a third embodiment of the present invention.

FIG. 5 explains how the present invention computes three-dimensional information.

FIG. 6 explains how the present invention controls an extension flash module to flash.

FIG. 7 shows an embodiment of an extension flash module of the present invention.

### DESCRIPTION OF THE PREFERRED EMBODIMENTS

The above and other technical details, features and effects of the present invention will be will be better understood with regard to the detailed description of the embodiments below, with reference to the drawings. The drawings as referred to throughout the description of the present invention are for illustration only, to show the interrelations between the apparatus and devices, but not drawn according to actual scale.

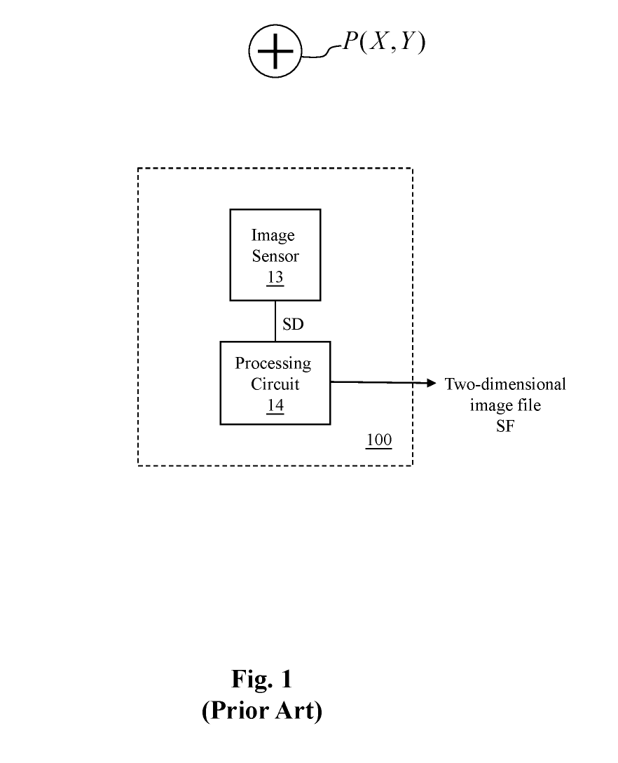

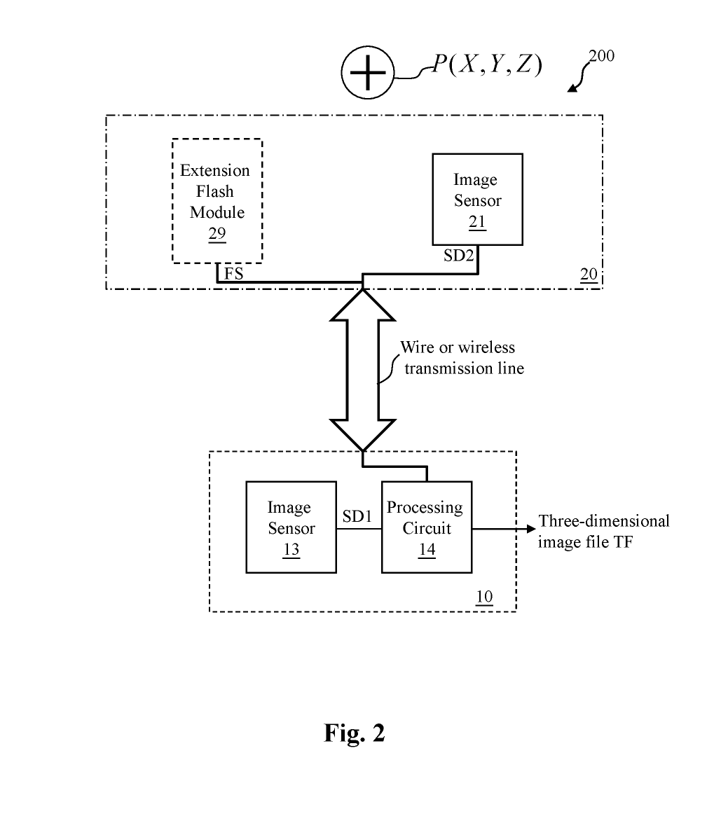

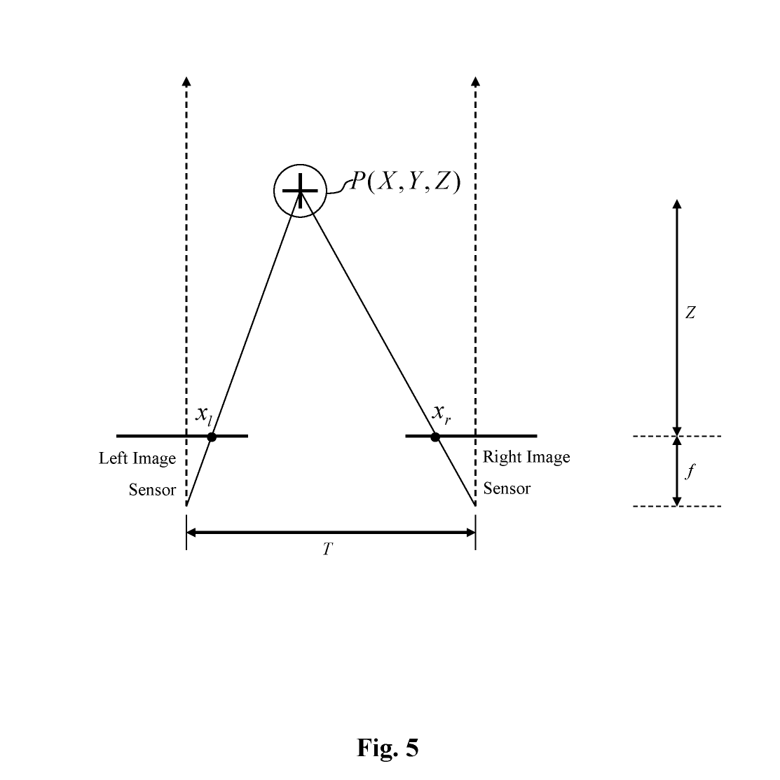

Please refer to FIG. 2 in conjugation with FIG. 5. FIG. 2 shows a block diagram of an add-on auxiliary device for assisting in generating three-dimensional information according to a first embodiment of the present invention. FIG. 5 explains how the present invention computes three-dimensional information. The first embodiment 200 explains how the present invention, by providing an add-on auxiliary device 20 which is an external device attached or linked to a portable electronic device 10 having a two-dimensional photo taking function, generates three-dimensional information of an object P. The three-dimensional information is outputted to become a three-dimensional image file TF. In the first embodiment 200, the portable electronic device 10 only has a two-dimensional photo taking capability, and it includes a first image sensor 13 and a processing circuit 14. The first image senor 13 captures an image of the object P and generates first two-dimensional information SD1 corresponding to the object P, and such first two-dimensional information SD1 is transmitted to the processing circuit 14. The processing circuit 14 is coupled to the first image senor 13. Under a situation where the add-on auxiliary device 20 is absent, the processing circuit 14 can process the first two-dimensional information SD1 to generate a two-dimensional image file (not shown; please refer to FIG. 1) of the object P. In one embodiment, the processing circuit 14 can be any circuit having a data computation function such as a CPU, an MCU, a DSP, or an ASIC.

In one embodiment, the add-on auxiliary device 20 comprises at least one second image sensor 21, which is configured to operably communicate with the portable electronic device 10 via a wired or wireless transmission line. The second image sensor 21 captures an image of the object P and generates second two-dimensional information SD2 corresponding to such image, which is transmitted to the processing circuit 14 via the above-mentioned transmission line. Thus, the processing circuit 14 can compute three-dimensional information of the object P according to the first two-dimensional information SD1 and the second two-dimensional information SD2, to generate a three-dimensional image file TF of the object P.

FIG. 5 explains how the processing circuit 14 generates the three-dimensional image file TF of the object P according to the first two-dimensional information SD1 and the second two-dimensional information SD2. When there are two image sensors (in the first embodiment 200, the two image sensors shown in FIG. 5 corresponds to the first image sensor 13 and the second image sensor 21), referring to FIG. 5, assuming that the distance between the centers of the two image sensors is T; the focal distance of each of the image sensors is f; the captured image includes an object P, and the object's horizontal position as seen from the left sensor is xl, while its horizontal position as seen from the right sensor is xr (xr is a negative value since it is located at the left side of the right sensor); and the projected distance between the object P and each of the sensors is Z; it can thus be obtained that

xl/f=X/Z, and −xr/f=(T−X)/Z

Thus, the three-dimensional information of the object P can be obtained as:

X=(T×xₗ)/(xₗ−xᵣ)

Y=(T×yₗ)/(xₗ−xᵣ)(wherein yₗ is not shown in the figure)

Z=f×[T/(xₗ−xᵣ)]

By means of the above, the three-dimensional information of the object P can be obtained, and the three-dimensional image file TF of the object P can be obtained according to the three-dimensional information of the object P. Certainly, the three-dimensional image file TF of the object P does not only include one single coordinate; the above calculation is simplified for simplicity of the explanation.

Moreover, the above-mentioned calculation is based on an assumption that the left and right sensors are aligned on a horizontal line, but it does not have to be so. In another embodiment, if the two sensors are not aligned on a horizontal line, that is, there is a relative angle between them, the present invention can still calculate the three-dimensional image file TF of an object P according to the relative angle and the above-mentioned other parameters. The details for such calculation are already known by one skilled in this art and are omitted here.

It should be noted that the above is only one among many possible ways to obtain three-dimensional image file TF according to calculated three-dimensional information of the object P. The calculation of the three-dimensional information may be done by other ways, as those skilled in this art may conceive under the teaching by the present invention.

Please still refer to FIG. 2. In another embodiment, the add-on auxiliary device 20 can optionally comprise an extension flash module 29 (illustrated by dashed line to show that it is optional). The extension flash module 29 can provide supplemental light during the photo taking procedure. Because an extension flash module 29 is one of the most often used add-on auxiliary device in cooperation with a portable electronic device, it will be very convenient for the user to integrate the three-dimensional information generation function within an extension flash module.

In one embodiment, the extension flash module 29 flashes according to a flash instruction FS, which is received from the portable electronic device 10. Because the portable electronic device 10 might be concurrently executing multiple processes in parallel under multitasking, if the portable electronic device 10 simply issues an action instruction to the extension flash module 29 and the extension flash module 29 simply flashes according to this action instruction, the actual photo taking timing of the portable electronic device 10 might not match the flash timing; that is, processing one or more other tasks might delay the actual photo taking timing of the portable electronic device 10, such that the timing at which the extension flash module 29 actually flashes is not in synchronization with the photo taking timing of the portable electronic device 10. To overcome such drawback, the present invention proposes two solutions, as described below.

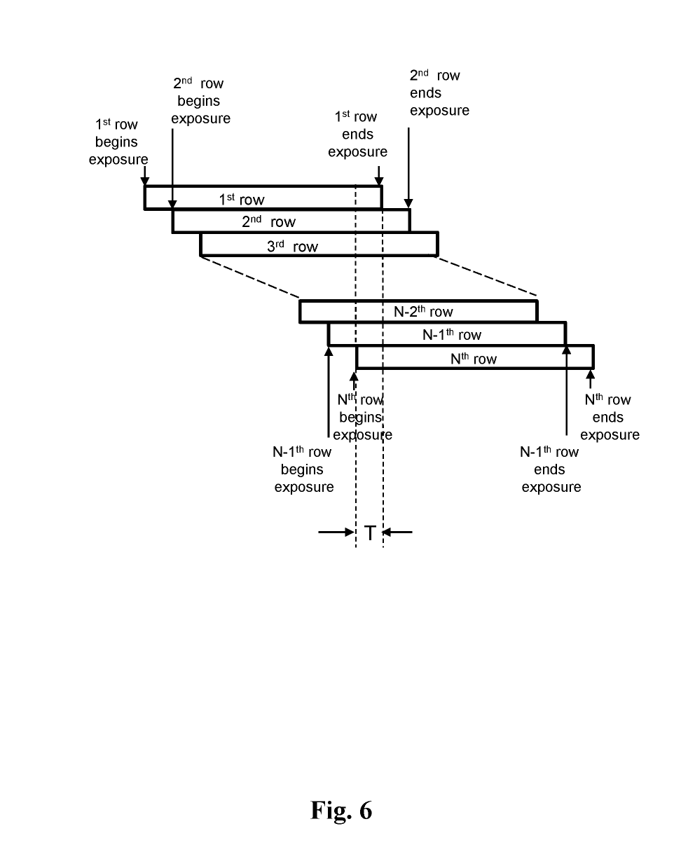

Referring to FIG. 6 for the first solution: an image senor includes multiple rows of photo sensors, and an image is captured by exposing the photo sensors row by row in sequence. Therefore, once the first row of photo sensors begins exposure, the exposure time for each of the rest rows of the photo sensors becomes known. According to the present invention, a specific event can be predetermined as a reference time point. The specific event for example can be a timing at which one of the rows of the photo sensors of the first or the second image sensor begins exposure. A fixed delay time is computed according to such reference time (the delay time can be equal to or greater than zero), and a flash is triggered after such fixed delay time from when the specific event occurs. The specific event can be any other event or timing, as long as the actual photo taking timing of the portable electronic device 10 is known from this event or timing. For example, it is also practicable and within the scope of the present invention that the specific event is a timing at which one of the rows of the photo sensors of the first or the second image sensor ends exposure.

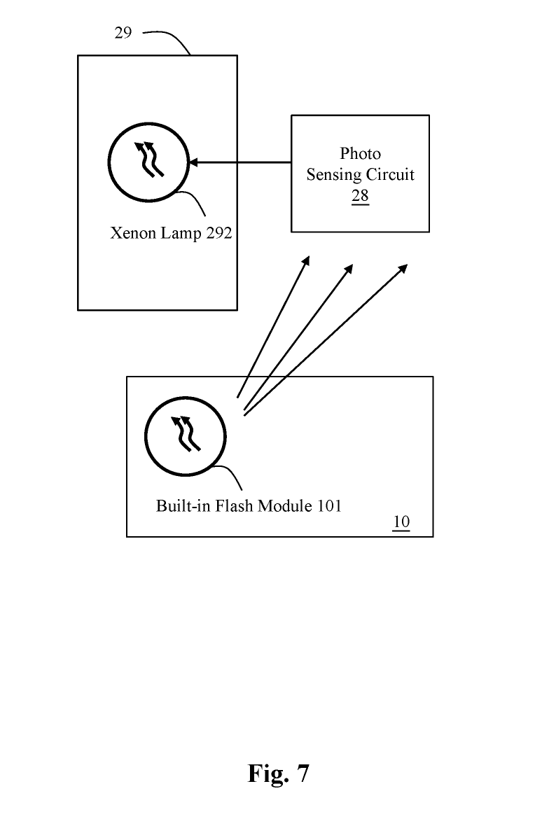

For the second solution, please refer to FIG. 7. In this embodiment, the portable electronic device 10 includes a built-in flash module 101, while the add-on auxiliary device 20 (or the add-on auxiliary device 30 and 40, which will be described later) includes a photo sensing circuit 28. The extension flash module 29 includes, for example but not limited to, a xenon lamp 292. The photo sensing circuit 28 senses flash light emitted by the built-in flash module 101. As (i.e., when or shortly after) the photo sensing circuit 28 senses the flash light from the built-in flash module 101, the photo sensing circuit 28 will issue a signal, and the extension flash module 29 can flash according to this signal. Note that, if this solution is adopted, it is not necessary to provide the above-mentioned flash instruction FS because the extension flash module 29 does not flash according to the flash instruction FS.

Please refer back to FIG. 6. The optimal flashable time of the extension flash module 29 falls within a period T, in which all of the photo sensor rows can be fully exposed. As mentioned above, such period T can be obtained by computing a delay time according to a specific event. This specific event can be a timing at which one of the rows of the first or second image sensor begins exposure or ends exposure, or a flash time of the built-in flash module 101.

On the other hand, when the present invention generates the three-dimensional information of the object P according to the first two-dimensional information SD1 and the second two-dimensional information SD2, preferably, these two two-dimensional information SD1 and SD2 should be captured concurrently at the same time. However, because the two-dimensional information SD1 and SD2 are separately obtained by the portable electronic device 10 and the add-on auxiliary device 20, the same problem that “the actual photo taking timing of the portable electronic device 10 might be delayed due to multi-tasking processing whereby the two-dimensional information SD1 and SD2 are not captured at the same time” also exists. According to the present invention, the same as the approach to obtain the optimal flashable time T, the optimal image capturing time for the two-dimensional information SD1 and SD2 can be obtained by computing a delay time according to a specific event. This specific event can be a timing at which one of the rows of the first or second image sensor begins exposure or ends exposure, or a flash time of the built-in flash module 101. Note that, the optimal image capturing time for the two-dimensional information SD1 and SD2, and the above-mentioned period T, can be mutually independent and irrelevant to each other (because it is not necessary for the add-on auxiliary device 20 to include an extension flash module 29). Nevertheless, if the add-on auxiliary device 20 includes an extension flash module 29, the optimal image capturing time for two-dimensional information SD1 and SD2 should preferably, but not necessarily, fall within the above-mentioned period T (because the user might intend to create some peculiar photo effect with partial exposure).

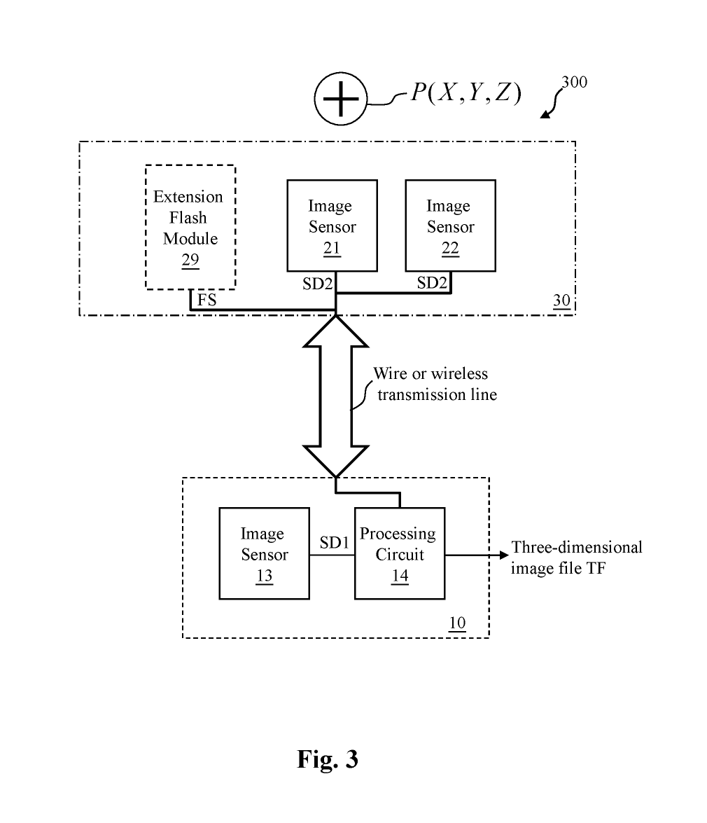

Please refer to FIG. 3, which shows a block diagram of an add-on auxiliary device for assisting in generating three-dimensional information according to a second embodiment of the present invention. The second embodiment 300 is similar to the first embodiment 200, but is different in that: the add-on auxiliary device 30 of the second embodiment 300 includes two second image sensors 21 and 22, from which the three-dimensional information is generated, while in the add-on auxiliary device 20 of the first embodiment 200, the three-dimensional image file TF of the object P is generated through at least one second image sensors 21 in cooperation with the first image sensor 13 of the portable electronic device 10. In the second embodiment 300, because the add-on auxiliary device 30 includes two second image sensors 21 and 22, the three-dimensional information can be generated without the cooperation from the first image sensor 13 of the portable electronic device 10 (however, if intended, it is also practicable to integrate the image information captured by first image sensor 13 and the two second image sensors 21 and 22). In the second embodiment 300, the processing circuit 14 can compute three-dimensional information of the object P according to two two-dimensional information SD2 generated by two second image sensors 21 and 22, thus generating three-dimensional image file TF of the object P. Similar to the first embodiment 200, the add-on auxiliary device 30 of this embodiment 300 can optionally comprise an extension flash module 29. The flashable time of the extension flash module 29 can be controlled through, for example but not limited to, the above-mentioned approaches. Certainly, the add-on auxiliary device 30 is not limited to including only two second image sensors 21 and 22; it can include three or even more second image sensors.

In addition to the above-mentioned differences, the second embodiment 300 and the first embodiment 200 have substantially the same advantages and efficacies, which are not redundantly repeated here.

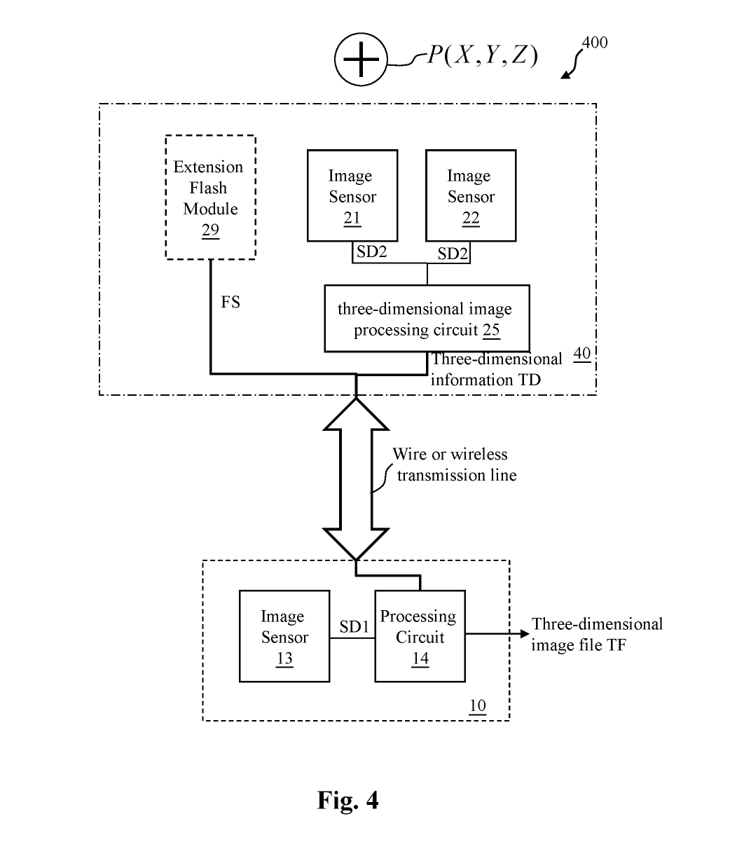

Please refer to FIG. 4, which shows a block diagram of an add-on auxiliary device for assisting in generating three-dimensional information according to a third embodiment of the present invention. The third embodiment 400 is similar to the first embodiment 200, but is different in that: the add-on auxiliary device 40 of the second embodiment 400 further includes a three-dimensional image processing circuit 25. In the second embodiment 300, the processing circuit 14 of the portable electronic device 10 receives two two-dimensional information SD2 and generates the three-dimensional image file TF of the object P. In contrast, in the third embodiment 400, the three-dimensional image processing circuit 25 of the add-on auxiliary device 40 receives two two-dimensional information SD2 and generates three-dimensional information of the object P. Such three-dimensional information is transmitted to the processing circuit 14 of the portable electronic device 10 via the transmission line, for generating the three-dimensional image file TF of the object P.

Similar to the above-mentioned embodiments 200 and 300, the add-on auxiliary device 40 of this embodiment 400 can optionally comprise an extension flash module 29. The flashable time of the extension flash module 29 can be controlled through, for example but not limited to, the above-mentioned approaches.

In addition to the above-mentioned differences, the third embodiment 400 and the second embodiment 300 have substantially the same advantages and efficacies, which are not redundantly repeated here.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. In view of the foregoing, the spirit of the present invention should cover all such and other modifications and variations, which should be interpreted to fall within the scope of the following claims and their equivalents.

What is claimed is:

1. An add-on auxiliary device for assisting in generating three-dimensional information, wherein the add-on auxiliary device is an external device configured to be attached or linked to a portable electronic device having a camera function, the portable electronic device including a first image sensor configured to operably capture first two-dimensional information of an object, and a processing circuit coupled to the first image sensor, wherein the processing circuit is configured to operably process the first two-dimensional information, the add-on auxiliary device comprising:
at least one second image sensor configured to operably capture second two-dimensional information of the object; and
a transmission line configured to operably transmit the second two-dimensional information to the processing circuit;
whereby, the processing circuit generates three-dimensional information of the object according to the first two-dimensional information and the second two-dimensional information.

2. The add-on auxiliary device for assisting in generating three-dimensional information of claim 1, wherein the add-on auxiliary device further comprises:
an extension flash module configured to operably provide supplemental light while the second image sensor is capturing the second two-dimensional information of the object.

3. The add-on auxiliary device for assisting in generating three-dimensional information of claim 2, wherein the extension flash module is configured to trigger a flash after a fixed delay time from an occurrence of a specific event, wherein the specific event is a timing at which one photo sensor row of the first or the second image sensor begins exposure or ends exposure.

4. The add-on auxiliary device for assisting in generating three-dimensional information of claim 2, wherein the portable electronic device has a built-in flash module, the add-on auxiliary device further comprising: a photo sensing circuit configured to operably sense a flash timing of the built-in flash module, the add-on auxiliary device being controlled by the photo sensing circuit to flash according to the flash timing of the built-in flash module.

5. The add-on auxiliary device for assisting in generating three-dimensional information of claim 1, wherein the second image sensor captures the second two-dimensional information of the object after a fixed delay time from an occurrence of a specific event, so that an image capturing time of the second two-dimensional information is synchronous with an image capturing time of the first two-dimensional information captured by the first image sensor.

6. The add-on auxiliary device for assisting in generating three-dimensional information of claim 1, wherein the portable electronic device includes a built-in flash module, and as the add-on auxiliary device senses a flash timing of the built-in flash module, the second image sensor captures the second two-dimensional information of the object, so that an image capturing time of the second two-dimensional information is synchronous with an image capturing time of the first two-dimensional information captured by the first image sensor.

7. The add-on auxiliary device for assisting in generating three-dimensional information of claim 2, wherein the extension flash module includes a xenon lamp.

8. An add-on auxiliary device for assisting in generating three-dimensional information, wherein the add-on auxiliary device is an external device configured to be attached or linked to a portable electronic device having a camera function, the portable electronic device including a first image sensor configured to operably capture first two-dimensional information of an object and a processing circuit coupled to the first image sensor, wherein the processing circuit is configured to operably process the first two-dimensional information, the add-on auxiliary device comprising:
a plurality of second image sensors configured to operably capture a plurality of second two-dimensional information of the object; and
a transmission line configured to operably transmit the plurality of second two-dimensional information to the processing circuit;
whereby, the processing circuit generates the three-dimensional information of the object according to the plurality of second two-dimensional information.

9. The add-on auxiliary device for assisting in generating three-dimensional information of claim 8, wherein the add-on auxiliary device further comprises:
an extension flash module configured to operably provide supplemental light while the second image sensor is capturing the second two-dimensional information of the object.

10. The add-on auxiliary device for assisting in generating three-dimensional information of claim 9, wherein the extension flash module is configured to trigger a flash after a fixed delay time from an occurrence of a specific event, wherein the specific event is a timing at which a photo sensor row of the first or the second image sensor begins exposure or ends exposure.

11. The add-on auxiliary device for assisting in generating three-dimensional information of claim 9, wherein the portable electronic device includes a built-in flash module, the add-on auxiliary device further comprising: a photo sensing circuit configured to operably sense a flash timing of the built-in flash module, the add-on auxiliary device being controlled by the photo sensing circuit to flash according to the flash timing of the built-in flash module.

12. The add-on auxiliary device for assisting in generating three-dimensional information of claim 9, wherein the extension flash module includes a xenon lamp.

13. An add-on auxiliary device for assisting in generating three-dimensional information, wherein the add-on auxiliary device is an external device configured to be attached or linked to a portable electronic device having a camera function, the portable electronic device including a first image sensor configured to operably capture first two-dimensional information of an object and a processing circuit coupled to the first image sensor, wherein the processing circuit is configured to operably process the first two-dimensional information, the add-on auxiliary device comprising:
a plurality of second image sensors configured to operably capture a plurality of second two-dimensional information of the object;
a three-dimensional image processing circuit configured to operably generate three-dimensional information of the object according to the plurality of second two-dimensional information; and
a transmission line configured to operably transmit the three-dimensional information to the processing circuit.

14. The add-on auxiliary device for assisting in generating three-dimensional information of claim 13, wherein the add-on auxiliary device further comprises:
an extension flash module configured to operably provide supplemental light while the second image sensor is capturing the second two-dimensional information of the object.

15. The add-on auxiliary device for assisting in generating three-dimensional information of claim 14, wherein the extension flash module is configured to trigger a flash after a fixed delay time from an occurrence of a specific event, wherein the specific event is a timing at which one photo sensor row of the first or the second image sensor begins exposure or ends exposure.

16. The add-on auxiliary device for assisting in generating three-dimensional information of claim 14, wherein the portable electronic device has a built-in flash module, the add-on auxiliary device further comprising: a photo sensing circuit configured to operably sense a flash timing of the built-in flash module, the add-on auxiliary device being controlled by the photo sensing circuit to flash according to the flash timing of the built-in flash module.

17. The add-on auxiliary device for assisting in generating three-dimensional information of claim 14, wherein the extension flash module includes a xenon lamp.
